(19) United States
(12) Patent Application Publication
(10) Pub. No.: US 2012/0226628 A1
(43) Pub. Date: Sep. 6, 2012

(54) Mathematical model of holographic natural K-line and its application to technology analysis for securities

(76) Inventor: Jiayong Dai, Guilin (CN)

(21) Appl. No.: 13/141,653

(22) PCT Filed: Jan. 12, 2010
(86) PCT No.: PCT/CN2010/000052

§ 371 Date: Jun. 22, 2011

(30) Foreign Application Priority Data
Nov. 30, 2009 (CN) 200910252359.7

(51) Int. Cl. G06Q 40/06

(52) U.S. Cl. 705/36 R

(57) ABSTRACT

The present invention relates to the stock and securities technology analysis field and discloses a mathematical model of holographic natural K-line and its graph technology index. It takes the closing price of yesterday as comparison reference, and is relatively stable and well connected, which is a scientific stock price changing expression that follows the order of nature, traditional culture and thinking habit. It scientifically defines the yin and yang nature of K-line relative to the closing price of yesterday, correctly reflects the gaming process and power change of buyer and seller. It solves the problem of illegibility, loose, and misguidance of the traditional K-line with opening price as reference, expands the definition and theory of the traditional K-line, and is easy to learn and operate with more abundant information concise graph and more dynamic sense. It provides scientific core stock price graph index and good foundation for stock technology analysis, and can widely applied to the analysis for securities such as stock and futures.

### BACKGROUND OF THE PRESENT INVENTION

1. Field of Invention

The present invention relates to a technology analysis for securities and stocks, and more particularly to a mathematical model of holographic natural K-line and a graph technology index of holographic natural K-line, which is new-style and constructed in form K-line and its application to technology analysis for securities.

2. Description of Related Arts

The stock price lines are importance curves to describe the stock price trend in existing stock and securities technology analysis, and are core and foundation of all stock technology analysis, which constitute the most common main graph core index of stock technology analysis software.

In the existing traditional stock technology analysis, the stock price lines include CLOSE, SCLOSE, MTOW, BAR from US and K-line from Japan.

In these five types of stock price lines, the traditional K-line is widely acknowledged around the world, and becomes the most popular main graph stock price index. K-line contains the opening price, highest price, lowest price, and closing price, shaped like candles, which concisely and fully describes the price change during the whole day and constitutes intuitionistic and abundant trade information with vivid pattern. Therefore, K-line technology analysis method and technique have become a very important technology analysis theory in securities and stock technology analysis over the past 200 years.

However, the design theory of the traditional mathematical model and graph technology index of traditional K-line has obvious drawbacks, such as illegibility, loose, and misguidance, which are illustrated as below.

1. The determination of rise and fall of K-line is based on the opening price, which cause the illegibility of the yin or yang K-line.

2. When the length of entity of K-line opens low or opens high at gap, the range of the definition of entity has drawback of over large or over small.

3. The definition of the gap of K-line only includes pure vacuum gap, which is too narrow.

4. The upper and lower shadow cannot correctly reflect the true power of buyer and seller in the game.

5. The K-lines of today and yesterday are not well connected and not relevant enough.

The actual embodiments of the above-mentioned drawbacks are explained as below.

(1) False yin line appears when the opening price of today jumps high at gap, and the closing price is higher than the closing price of yesterday but lower than the opening price of today.

(2) False yang line appears when the opening price of today jumps low at gap, and the closing price is lower than the closing price of yesterday but higher than the opening price of today.

(3) The relatively longer entity of yang K-line cannot truly reflect the minor changes of the closing price of today relative to the closing price of yesterday, when the stock price of today opens low but the closing price of today is slightly higher than the closing price of yesterday.

(4) The relatively longer entity of yin K-line cannot truly reflect the minor changes of the closing price of today relative to the closing price of yesterday, when the stock price of today opens high but closing price of today is slightly lower than the closing price of yesterday.

(5) The entity of yang K-line is too small to truly reflect the big changes of the closing price of today relative to the closing price of yesterday, when the stock price of today opens high and closes higher.

(6) The entity of yin K-line is too small to truly reflect the big changes of the closing price of today relative to the closing price of yesterday, when the stock price of to today opens low and closes lower.

(7) The rising gap of stock price is based on the lowest price of today and the highest price of yesterday, which neglects the rising gap of upper shadow line type and the rising gap of embedding type under entity shadow of left K-line, when the lowest price of today is lower than the highest price of yesterday but higher than the closing price of yesterday.

(8) The falling gap of stock price is based on the highest price of today and the lowest price of yesterday, which neglects the falling gap of lower shadow line type and the falling gap of embedding type under entity shadow of left K-line, when the highest price of today is higher than the lowest price of yesterday but lower than the closing price of yesterday.

These problems are generated from the principle of the mathematical model of the traditional K-line, which are the nature of the principle. The reason is that the K-line is based on the opening price of today, which is dynamic and unknown, so that the comparison standard is not relatively stable.

Therefore, the traditional K-line cannot fully, correctly, and accurately reflects the real condition and result of the game of buyer and seller, and cannot scientifically reflect the close relationship of stock price of today and yesterday.

Thereby, when the stock price trend are analyzed based on the traditional K-line, the illegibility, loose (the relationship of continuous days are not close), and misguidance of K-line graph cannot enable the investor to correctly read the changing process and results of the stock price game, so as to cause the wrong investment operation and investment lost due to the wrong analysis and judgment.

### SUMMARY OF THE PRESENT INVENTION

An object of the present invention is to provide a mathematical model of holographic natural K-line, and base on the mathematical model, constructs a holographic natural K-line graph technology index, that is holographic natural K-line, via a program of stock and securities technology analysis software, so as to fully and accurately reflects the information of all aspects, process and results of the comparison of the stock price relative to the closing price of yesterday and the game of the buyer and seller.

The mathematical model of holographic natural K-line of the present invention and the graph index of holographic natural K-line takes the closing price of yesterday as comparison reference, which is stable and relevant, and is a scientific expression of stock price calculation which conform the order of nature, traditional culture and thinking habit. The mathematical model of holographic natural K-line of the present invention can solve, overcome, and avoid the illegibility, loose, and misguidance of traditional K-line.

The present invention includes the mathematical model of holographic natural K-line and the graph technology index of holographic natural K-line.

Part I: The construction, principle, definition, and calculation formula of the mathematical model of holographic natural K-line (JK) are illustrated as below.

1. The construction of holographic natural K-line (JK)

The holographic natural K-line (JK) is consisted of result entity (SPJT), gap entity (SPJF), upper shadow line (UJL), lower shadow line (DJL), open warning line (OJW), five parts in total.

2. The principle and definition of holographic natural K-line (JK)

(1) The price of open warning line (OJW) of holographic natural K-line=the opening price of today;

(2) The entity of holographic natural K-line (SPJ):

The entity of holographic natural K-line (SPJ) takes the closing price of yesterday as comparison reference.

It includes two parts. The first part is the result entity of (SPJT) for the closing price (C) of today relative to the closing price (C2) of yesterday, which reflects the final result of the game of buyer and seller. The second part is the gap entity of (SPJF) for rising gap or falling gap of the price of today relative to the closing price (C2) of yesterday, which reflects that the stronger power overwhelm the weaker power in the game of buyer and seller.

The opening price of result entity (OJ)=the closing price of yesterday (C2) {C2=REF(C,1)}

The closing price of result entity (CJ)=the closing price of today (C)

The length of result entity (SPJTL)=the closing price of today (C)−the closing price of yesterday (C2)

The above is the definition and calculation formula of the result entity of holographic natural K-line. The principle and definition of the gap entity will be illustrated in the (5) as below.

(3) The highest price of holographic natural K-line HJ=the highest stock price of today H

(4) The lowest price of holographic natural K-line LJ=the lowest stock price of today L

(5) The principle and definition of the gap entity and upper and lower shadow line of holographic natural K-line (JK) are classified into three cases: even closing, higher closing and lower closing:

Case 1: Even closing when the stock price of today does not rise and fall

When the closing price of today (C) is equal to the closing price of yesterday (C2), that is C=C2, no rising gap or falling gap exists. In this case, the definition of upper and lower shadow line is illustrated as below.

The position of the upper shadow line (UJL): the highest price of today H˜the closing price of today (C)

The length of the upper shadow line (UJL)=the highest price of today H−the closing price of today (C)

The position of the lower shadow line (DJL): the lowest price of today L˜the closing price of yesterday (C2)

The length of the lower shadow line (DJL)=the lowest price of today L−the closing price of yesterday (C2)

Case 2: Higher closing when the stock price of today rises

When the closing price of today (C) is higher than the closing price of yesterday (C2), that is C>C2, there will be two cases.

(a) If the lowest price of today L is lower or equal to the closing price of yesterday (C2), that is C>C2 and L <=C2, relative to the closing price of yesterday (C2), it is defined that there is no rising gap of holographic natural K-line. In this case, the definition of the upper and lower shadow line is shown as below.

The position of the upper shadow line (UJL): the highest price of today H˜the closing price of today C

The length of the upper shadow line (UJL)=the highest price of today H−the closing price of today C

The position of the lower shadow line (DJL): the lowest price of today L˜the closing price of yesterday (C2)

The length of the lower shadow line (DJL)=the lowest price of today L−the closing price of yesterday (C2) (b) If the lowest price of today L is higher than the closing price of yesterday (C2), that is O>C2, C>C2 and L>C2, relative to the closing price of yesterday (C2), it is defined as there being the rising gap of holographic natural K-line, no matter whether the lowest price of today L is higher than the highest price of yesterday H2 or not. In this case, the calculation formula of the rising gap is defined as below.

The start price of the gap entity OJF=the closing price of yesterday (C2)

The final price of the gap entity CJF=the lowest price (L)

The length of the gap entity SPJFL=the lowest price of today L−the closing price of yesterday C2 (Positive value)

Further, in this case, the upper and lower shadow lines are defined as below.

The position of the upper shadow line (UJL): the highest price of today H˜the closing price of today C

The length of the upper shadow line (UJL)=the highest price of today H−the closing price of today C

The position of the lower shadow line (DJL): in this case the lower shadow line does not exist and the length of it is O.

Case 3: Lower closing when the stock price of today falls

When the closing price of today (C) is lower than the closing price of yesterday (C2), that is C<C2, there will be two cases.

(a) If the highest price of today H is higher or equal to the closing price of yesterday (C2), that is C<C2 and H>=C2, relative to the closing price of yesterday (C2), It is defined there is no falling gap of holographic natural K-line. In this case, the upper shadow line is defined as below.

The position of the upper shadow line (UJL): the highest price of today H˜the closing price of yesterday (C2)

The length of the upper shadow line (UJL)=the highest price of today H−the closing price of yesterday (C2)

The position of the lower shadow line (DJL): the lowest price of today L˜the closing price of today (C)

The length of the lower shadow line (DJL)=the lowest price of today L−the closing price of today (C) (b) If the highest price of today H is lower than the closing price of yesterday

(C2), that is O<C2, C<C2 and H<C2, relative to the closing price of yesterday (C2), it is defined as there being the falling gap of holographic natural K-line, no matter whether the highest price of today H is lower than the lowest price of yesterday L2 or not. In this case, the calculation formula of the falling gap is defined as below.

The start price of the gap entity OJF=the closing price of yesterday (C2)

The final price of the gap entity CJF=the highest price (H)

The length of the gap entity SPJFL=the highest price of today H−the closing price of yesterday C2 (negative value)

Further, in this case, the upper and lower shadow lines are defined as below.

The position of the upper shadow line (UJL): in this case the upper shadow line does not exist and the length of it is 0

The position of the lower shadow line (DJL): the lowest price of today L˜the closing price of today C

The length of the lower shadow line (DJL)=the lowest price of today L−the closing price of today C

3. The calculation formula and method of these five parts of the mathematical model of holographic natural K-line are illustrated as below.

There are three cases: even closing, higher closing and lower closing, when comparing the stock price of today with the closing price of yesterday. According to the five principles and definitions of the mathematical model of holographic natural K-line, the calculation formula of all values of the holographic natural K-line is defined as below.

(1). When the stock price of today does not rise or fall:

That is to say, when the closing price of today C is equal to the closing price of yesterday, that is C=C2, the calculation formula of all values are shown as below:

The price of open warning line OJW=the opening price of today O

The start price of the result entity OJ=the closing price of yesterday C2; {C2=REF(C, 1)}

The closing price of the result entity CJ=the closing price of today C; {C=C2)}

The length of result entity SPJTL=the closing price of today C−the closing price of yesterday C2=0

The length of entity SPJFL=the closing price of today C−the closing price of yesterday C2=0

The position of upper shadow line UJL: the highest price of today H˜the closing price of today C

The length of upper shadow line UJL=the highest price of today H−the closing price of today C

The position of lower shadow line DJL: the lowest price of today L˜the closing price of yesterday C2

The length of lower shadow line DJL=the lowest price of today L−the closing price of yesterday C2

In this case, relative to the closing price of yesterday C2, the holographic natural K-line is a crossing line without gap entity, which means that the length of result entity and gap entity are zero.

(2). When the stock price of today rises:

That is to say, when the closing price of today C is higher than the closing price of yesterday, that is C>C2, there will be two cases:

(a). if the lowest price of today is lower or equal to the closing price of yesterday C2, that is if C>C2 and L<=C2, the calculation formula of all values are shown as below:

The price of open warning line OJW=the opening price of today O

The start price of the result entity OJ=the closing price of yesterday C2; {C2=REF(C, 1)}

The closing price of the result entity CJ=the closing price of today C;

The length of result entity SPJTL=the closing price of today C−the closing price of yesterday C2

The start price of gap entity OJF=the closing price of yesterday C2;

The length of gap entity SPJFL=zero, {that is gap entity does not exist};

The position of upper shadow line UJL: the highest price of today H˜the closing price of today C;

The length of upper shadow line UJL=the highest price of today H−the closing price of today C;

The position of lower shadow line DJL: the lowest price of today L˜the closing price of yesterday C2;

The length of lower shadow line DJL=the lowest price of today L−the closing price of yesterday C2;

Now, relative to the closing price of yesterday C2, the holographic natural K-line is a rising yang line without gap entity, which means that the length of gap entity is zero.

(b). if the lowest price of today L is higher than the closing price of yesterday C2, that is if O>C2 and C>C2 and L>C2, the calculation formulas of all values are shown as below:

The price of open warning line OJW=the opening price of today O;

The start price of the result entity OJ=the closing price of yesterday C2; {C2=REF(C, 1)}

The closing price of the result entity CJ=the closing price of today C;

The length of result entity SPJTL=the closing price of today C−the closing price of yesterday C2;

The start price of gap entity OJF=the closing price of yesterday C2;

The final price of gap entity CJF=the lowest price of today L;

The length of gap entity SPJFL=the lowest price of today L−the closing price of yesterday C2;

The position of upper shadow line UJL: the highest price of today H˜the closing price of today C;

The length of upper shadow line UJL=the highest price of today H−the closing price of today C;

The position of lower shadow line DJL: the lower shadow line does not exist;

The length of lower shadow line DJL=0;

Now, relative to the closing price of yesterday C2, the holographic natural K-line (JK) is a rising yang line and rising gap entity exists, but the lower shadow line does not exist.

(3). When the stock price of today falls:

That is to say, when the closing price of today C is lower than the closing price of yesterday C2, that is C<C2, there will be two cases:

(a). if the highest price of today H is higher or equal to the closing price of yesterday C2, that is C<C2 and H>=C2, the calculation formulas of all values are shown below:

The price of open warning line OJW=the opening price of today O;

The start price of the result entity OJ=the closing price of yesterday C2; {C2=REF(C, 1)}

The closing price of the result entity CJ=the closing price of today C;

The length of result entity SPJTL=the closing price of today C−the closing price of yesterday C2;

The start price of gap entity OJF=the closing price of yesterday C2;

The final price of gap entity CJF=the closing price of yesterday C2;

The length of gap entity SPJFL=zero, {that is falling gap does not exist};

The position of upper shadow line UJL: the highest price of today H˜the closing price of yesterday C2;

The length of upper shadow line UJL=the highest price of today H−the closing price of yesterday C2;

The position of lower shadow line DJL: the lowest price of today L˜the closing price of today C;

The length of lower shadow line DJL=the lowest price of today L−the closing price of today C;

Now, relative to the closing price of yesterday C2, the holographic natural K-line (JK) is a falling yin line without falling gap entity, which means that the length of gap entity is zero.

(b). if the highest price of today H is lower than the closing price of yesterday C2, that is O<C2 and H<C2 and C<C2, the calculation formulas of all values are shown below:

The price of open warning line OJW=the opening price of today O;

The start price of the result entity OJ=the closing price of yesterday C2; {C2=REF(C, 1)}

The closing price of the result entity CJ=the closing price of today C;

The length of result entity SPJTL=the closing price of today C−the closing price of yesterday C2;

The start price of gap entity OJF=the closing price of yesterday C2;

The final price of gap entity CJF=highest price of today H;

The length of gap entity SPJFL=the highest price of today H−closing price of yesterday C1; (negative value)

The position of upper shadow line UJL: the upper shadow line does not exist;

The length of upper shadow line DJL=0;

The position of lower shadow line DJL: the lowest price of today L˜the closing price of today C;

The length of lower shadow line DJL=the lowest price of today L−the closing price of today C;

Now, relative to the closing price of yesterday C2, the holographic natural K-line (JK) is a falling yin line and falling gap entity exists, but upper shadow line does not exist.

Part II: The holographic natural K-line graph technology index embodied as K-line based on mathematical model of holographic natural K-line is illustrated as below:

According to the construction, principle, definition, and calculation formula of the mathematical model of holographic natural K-line in Part I, a data will be obtained by classifying and calculating the changes of the stock price. And based on the data, a holographic natural K-line graph technology index that is holographic natural K-line, embodied as yin and yang K-line will be constructed. The holographic natural K-line is the core stock price technology index for stock price analysis, and provides important stock index, foundation and reference for stock price analysis.

1.The principle and construction of the holographic natural K-line graph technology index is shown as below:

(1) Draw an open warning line OJW of the holographic natural K-line with an opening price of today O, the line width of OJW is slightly wider than the width of the entity of K-line (generally 120%);

(2) Draw a result entity SPJT of K-line today beginning from the closing price of yesterday C2 and ending with the closing price of today C, which reflects the natural result of game between the buyer and seller today;

(3) Determine whether a gap of holographic natural K-line exists or not. If yes, draw the gap entity SPJF of K-line;

(4) Determine whether an upper and lower shadow line of holographic natural K-line exists or not, and draw the corresponding upper shadow line UJL and lower shadow line DJL.

2. The shape, size and color of the holographic natural K-line is shown as below:

(1) The graph and color of the holographic natural K-line graph technology index:

According to the traditional stock technology analysis habit, holographic natural K-line adopts the same kind of graph and color set with traditional K-line, which is embodied same with traditional K-line. If it rises when close, use red; if it falls when close, use green; if it does rise or fall, use white. The open warning line adopts a third color, such as gray or yellow for warning purpose.

(2) The size of the holographic natural K-line is shown as below:

According to the traditional stock technology analysis habit, the graph size of the holographic natural K-line, including the result entity, gap entity, upper shadow line, lower shadow line, adopts the same size with the traditional K-line. But the open warning line adopts a size slightly wider than the result entity of K-line, and uses different colors for warning purpose.

(3) Of course, these colors and sizes of the graph may change and have many options, such as black and white K-line, and the entity of K-line (result entity and gap entity) adopts broken lines and solid lines.

3. Below is the drawing method of K-line of three cases of even closing, higher closing and lower closing relative to the closing price of yesterday:

Open formula program function and language instructions of drawing software of stock and security technology analysis software can be used for drawing the holographic natural K-line. Here, the program of open formula manager of Tongdaxin stock technology analysis software is used for example.

The programming essentials of the holographic natural K-line graph technology index is shown as below:

{F. proceeding part: the value assignment of public parameter}

{The value assignment of the opening price, highest price, lowest price and closing price of yesterday and today}

O1:=OPEN;

C1:=CLOSE; {closing price of today}

C2:=REF (C1, 1); {closing price of yesterday}

H1:=HIGH;

H2:=REF (H1, 1);

L1:=LOW;

L2:=REF (L1, 1);

{N. definition and value assignment of each classification of holographic natural K-line}

{1. there is no gap in holographic natural K-line, when the stock closing price of today is equal to the closing price of yesterday}

{The value assignment of each parameter of the holographic natural}. . .

{2. When the closing price of today is higher than the closing price of yesterday}

{2.1.there may be rising gap entity in holographic natural K-line, when the stock closing price of today is higher than or equal to the closing price of yesterday}

TJ20:=IF (C1>=C2, 100, 0); {the value assignment of each value of the holographic natural K-line}

TJ20F:=IF (TJ20>0 && L1>C2, 100, 0) ;{determination on whether gap of holographic natural K-line exists or not}

OJ20:=IF (TJ20>0, C2, 0); {the value assignment of each value of the result entity}

CJ20:=IF (TJ20>0, C1, 0);

HJ20:=IF (TJ20>0, H1, 0);

LJ20J1:=MIN (L1, OJ20);

LJ20:=IF (TJ20>0, LJ20J1, 0);

OJ20F:=IF (TJ20>0, C2, C2); {the value assignment of the gap entity}

CJ20F:=IF (TJ20>0 && L1>C2, L1, C1);

OJ20T:=IF (TJ20>0 && L1>=C2, L1, C2) ; {the beginning price in the actual active area of K-line when there is a gap}

{3. When the closing price of today is lower than the closing price of yesterday}

{3.1.there may be falling gap in holographic natural K-line, when the stock closing price of today is lower than the closing price of yesterday}

TJ30:=IF (C1<C2, 100, 0); {the value assignment of each value of the holographic natural}

TJ30F:=IF (TJ30>0 && H1<C2, 100, 0) ; {determination on whether gap of holographic natural K-line exists or not}

OJ30:=IF (TJ30>0, C2, 0);

CJ30:=IF (TJ30>0, C1, 0); . . .

OJ30T:=IF (TJ30>0 && H1<C2, H1, C2) ;{the beginning price in the actual active area of K-line when there is a gap}

{4. draw holographic natural K-line graph of all cases respectively, according the above classifications}

{4.1 draw the open warning line of holographic natural K-line of all cases}

POJW: STICKLINE(DT1>0, OJW,OJW, 3 .6,1),COLORGRAY; {OJW=O1,opening price}

{4.2 draw the entity and upper and lower shadow line of holographic natural K-line of all cases}. . .

P20: DRAWKLINE (HD, OD, LD, CD);

{4.3 draw the gap entity that may exist of the holographic natural K-line of all cases}. . .

P20SPJFT: DRAWKLINE (CJFU, OJFU, OJFU, CJFU) ; {draw the rising gap entity}

P30SPJFF: DRAWKLINE (CJFD, OJFD, OJFD, CJFD) ; {draw the falling gap entity}

The main character of the holographic natural K-line is shown as below:

Comparing to the traditional K-line, the mathematical model of holographic natural K-line and the holographic natural K-line graph technology index has very distinct characters. The main character and the difference are illustrated as below:

1. The constitution of K-line is different

The holographic natural K-line includes the result entity, gap entity, upper shadow line, lower shadow line and open warning line, five parts in total. However, the traditional K-line only includes entity, upper shadow line and lower shadow line, three parts in total.

2. The differences between yin and yang, short and long of the entity are obvious:

(1) The reference and the character of the result entity of holographic natural K-line are definite, but the traditional K-line has illegibility;

(2) In most cases, the length of the result entity is different from that of the entity of traditional K-line.

3. The difference on gap is obvious:

(1) The gap of holographic natural K-line takes the closing price of yesterday C2 as reference;

(2) The gap of holographic natural K-line not only includes pure vacuum gap of traditional K-line, which shows the rising or falling of the stock price of today relative to the highest price or the lowest price of yesterday, but also includes the non-pure vacuum shadow line type gap of K-line with upper and lower shadow line and mix gap of both types; and in most cases, the length of gap entity of holographic natural K-line is longer than that of the traditional K-line.

4. The difference of the length of upper and lower shadow line is obvious:

(1) The holographic natural K-line takes the closing price of yesterday as reference, so that the result entity and gap entity are different from those of traditional K-line, and the upper shadow line and lower shadow line of holographic natural K-line are different of those of traditional K-line.

(2) When the stock price of today jumps low relative to the closing price of yesterday and the closing price is higher, the lower shadow line is obviously longer than that of the traditional K-line; when the stock price of today jumps high relative to the closing price of yesterday and the closing price is lower, the upper shadow line is obviously longer than that of the traditional K-line.

(3) Especially when there is a gap, the holographic natural K-line does not have lower shadow line when there is rising gap, and does not have upper shadow line when there is falling gap.

The main advantages of the holographic natural K-line is shown as below:

Comparing to the traditional K-line and other stock price lines of the existing stock technology analysis, the character of the holographic natural K-line is very unique and natural, and has obvious advantages as below:

1. It is a scientific stock price calculation and expression method that conform the order of nature, traditional culture and thinking habit.

2. It scientifically defines, classifies and reflects the yin and yang nature of K-line in the game of the buyer and seller relative to the closing price of yesterday, and accurately discloses the gaming process of buyer and seller relative to the closing price of yesterday, final result and the change of the power of both sides.

3. It enriches the classification, range and meaning of the gap, develops the gap theory and technique, and improves the analysis and knowledge of gap to a new era.

4. It adds an open warning line. With the shadow line and entity of holographic natural K-line, it objectively reflects the changes of the power of the buyer and seller for warning purpose.

5. It inherits the advantages of the traditional K-line of conciseness, graphic presentation, abundant, and does better.

6. It expands and enriches the definition and meaning of the traditional K-line, and effectively solves the problem of illegibility, loose, and misguidance of the traditional K-line.

7. It scientifically reflects the close connection between the continuous K-lines, and the power change of the buyers and sellers, for the investors to easily and accurately understand, analyze the stock price trend, and it provides full, abundant, accurate and necessary information and important technique foundation and technology index for further analysis.

8. It technically can restrain the banker to utilize the drawback of the traditional K-line to produce false K-line to cheat.

### BRIEF DESCRIPTION OF THE DRAWINGS

FIG. 1 is a schematic diagram of holographic natural K-line (two continuous K-lines):
(1) It consists of two continuous rising holographic natural K-lines:
First is a yang K-line with lower opening price and higher closing price, that is K2;
Second is a yang K-line with higher opening price, higher closing price and rising gap entity, that is K1;
(2) The abbreviations used in the holographic natural K-line in the figure mean:
\textcircled{1}SPJT: result entity of the holographic natural K-line;
\textcircled{2}SPJF: gap entity of the holographic natural K-line; (C2˜L1);
\textcircled{3}UJL: upper shadow line of holographic natural K-line;
\textcircled{4}DJL: lower shadow line of holographic natural K-line;
\textcircled{5}OJW: open warning line of holographic natural K-line;
The above-mentioned five parts constitute the mathematical model of holographic natural K-line, but not all K-line has gap entity and upper and lower shadow line.
(3) Other symbols
C3 is the closing price of last trade day of K2 yang line;
O2, H2, L2, C2 are opening price, highest price, lowest price, and closing price of K2 respectively;
O1, H1, L1, C1 are opening price, highest price, lowest price, and closing price of K1 respectively;
(4) Actual examples:
SZSE Component Index: 2009-9-2˜2009-9-3;
SSE Composite Index: 2008-4-23˜2008-4-24.

FIG. 2 is a schematic diagram of three types of single K-line of holographic natural K-line:
(1) From left to right, the examples of three single holographic natural K-lines are yang line with lower opening price and higher closing price, crossing line with lower opening price and even closing, and yin line with higher opening price and lower closing price.
(2) Symbols:
O, H, L, C are opening price, highest price, lowest price, and closing price of the K-line respectively; OJW is the open warning line of the K-line; C2 is the closing price of last day of the K-line.

FIG. 3 is the contrast figure between the traditional K-line of SZSE component index and the holographic natural K-line.
(1) The day K-line graph of 2009-8-24·2009-9-9
(2) Upper half part is traditional K-line, lower half part is holographic natural K-line, which are automatically generated by the holographic natural K-line JDKL4 of the present invention.

FIG. 4 is the contrast chart of the traditional K-line and the holographic natural K-line of GEEYA TECHNOLOGY stock.
(1) Day K-line graph is taken from the GEEYA TECHNOLOGY of 2009-10-30-2009-11-13, which is 300028 from Growth Enterprise Market
(2) Upper half part is traditional K-line, lower half part is holographic natural K-line;

FIG. 5 is a flow chart of program of holographic natural K-line graph technology index JDKL4.

FIG. 6 is a flow chart of application method of holographic natural K-line.

FIG. 7 is a statistical table of traditional K-line of SZSE component index and SSE composite index.
(1) Period: 2009-1-5˜2009-11-20 215 trade days;
(2) Brief explanation:
Upper half part is the generally classified statistics of yin and yang line of traditional K-line, lower half part is detailedly classified statistics of yin and yang line of traditional K-line. The percentage data in the table takes total trade days and actual rising amplitude as comparison reference. The data in the table reflects difference between the traditional K-line and the actual result, and discloses three drawbacks in nature.

FIG. 8 is a statistical table of holographic natural K-line of SZSE component index and SSE composite index.
(1) FIG. 8 is a statistical table of holographic natural K-line corresponding to FIG. 7.
(2) The data in the table reflects consistency between the holographic natural K-line and the actual result, which follows the order of the nature.
(3) The statistics charts of FIG. 7 and FIG. 8 are automatically calculated by computer programming software.

### DETAILED DESCRIPTION OF THE PREFERRED EMBODIMENT

1. The mathematical model of holographic natural K-line is applied to the stock and securities analysis via holographic natural K-line graph technology index that is embodied as K-line.

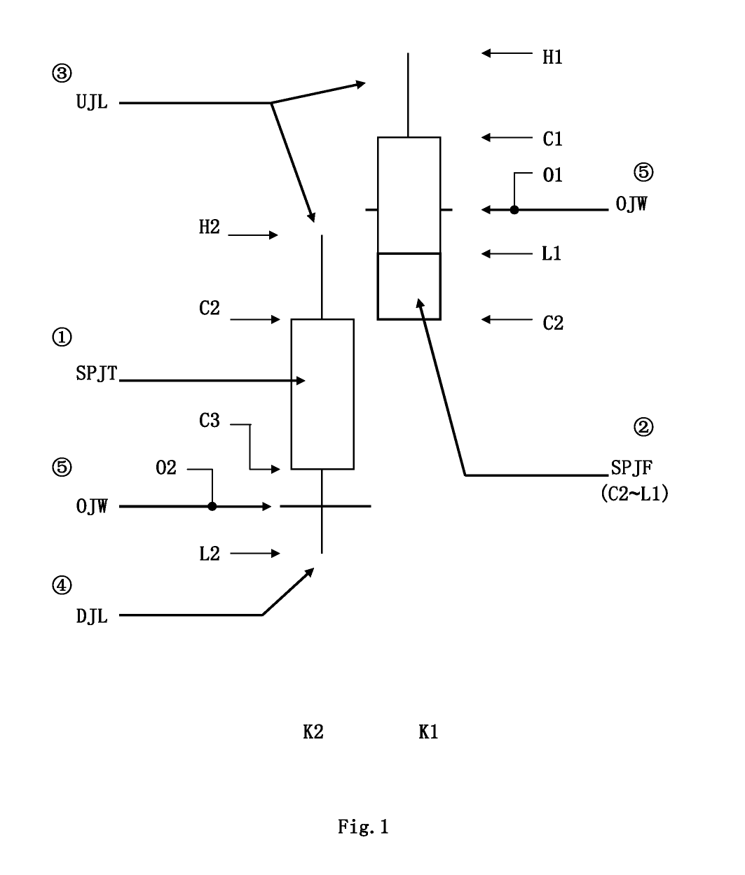

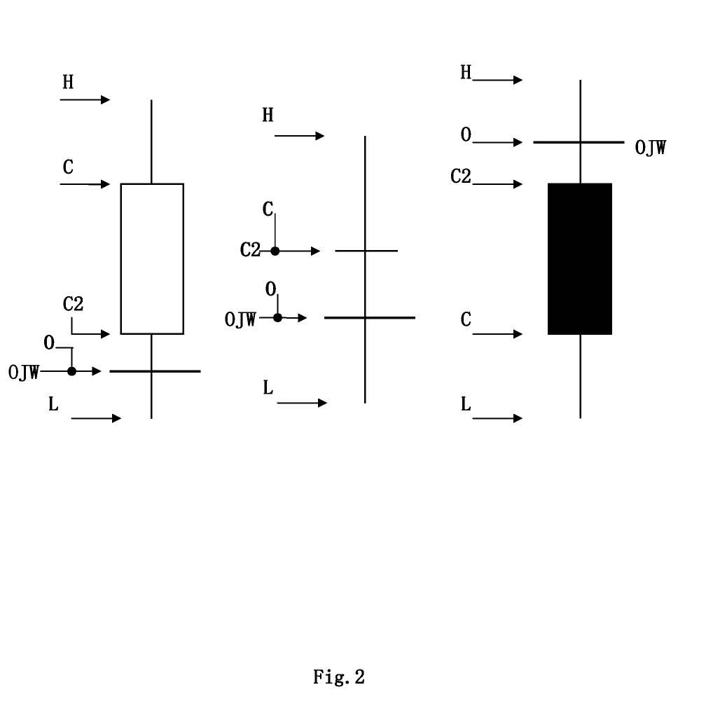

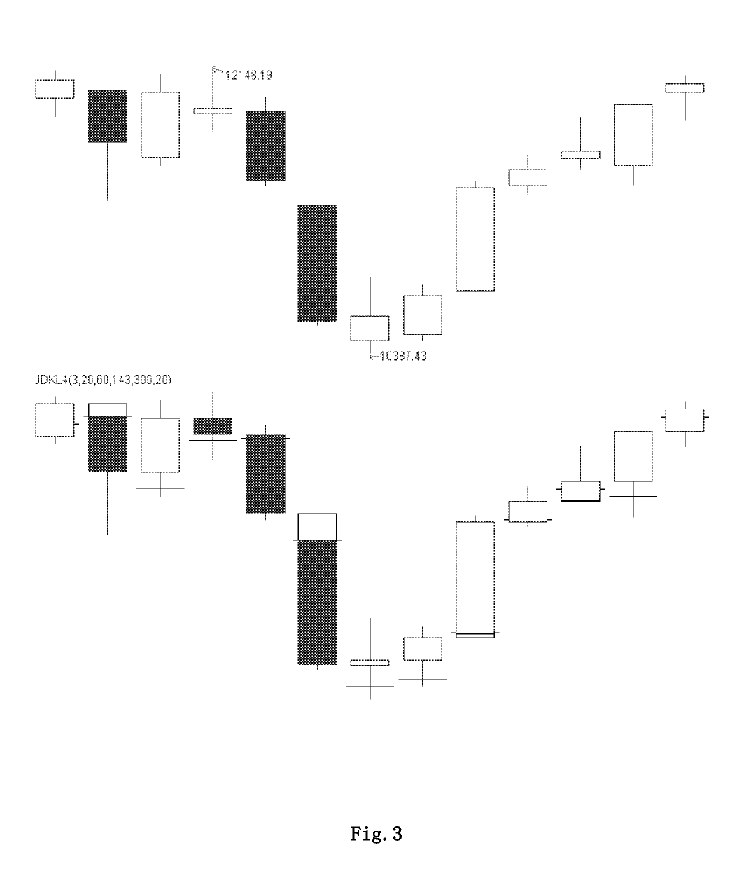

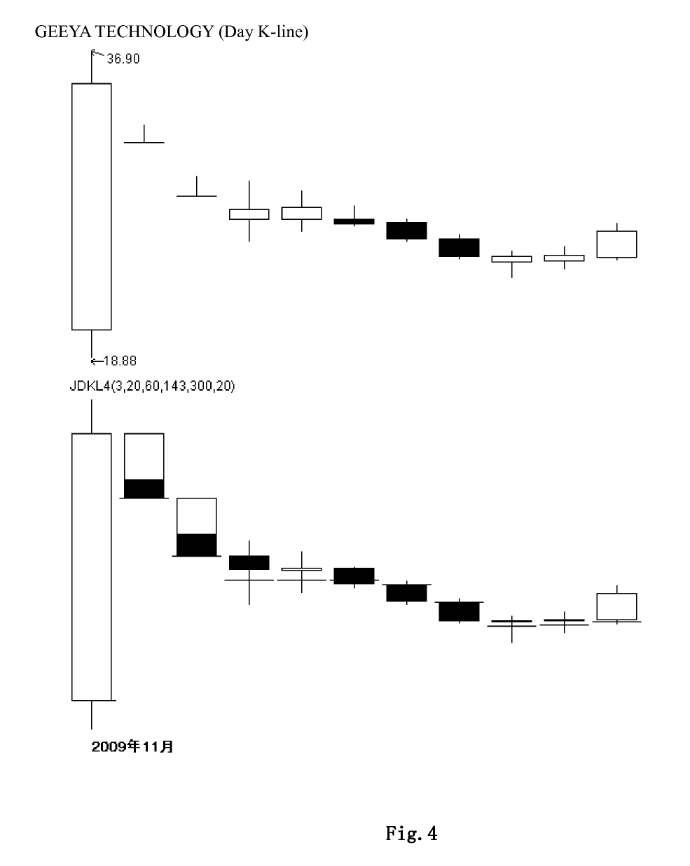

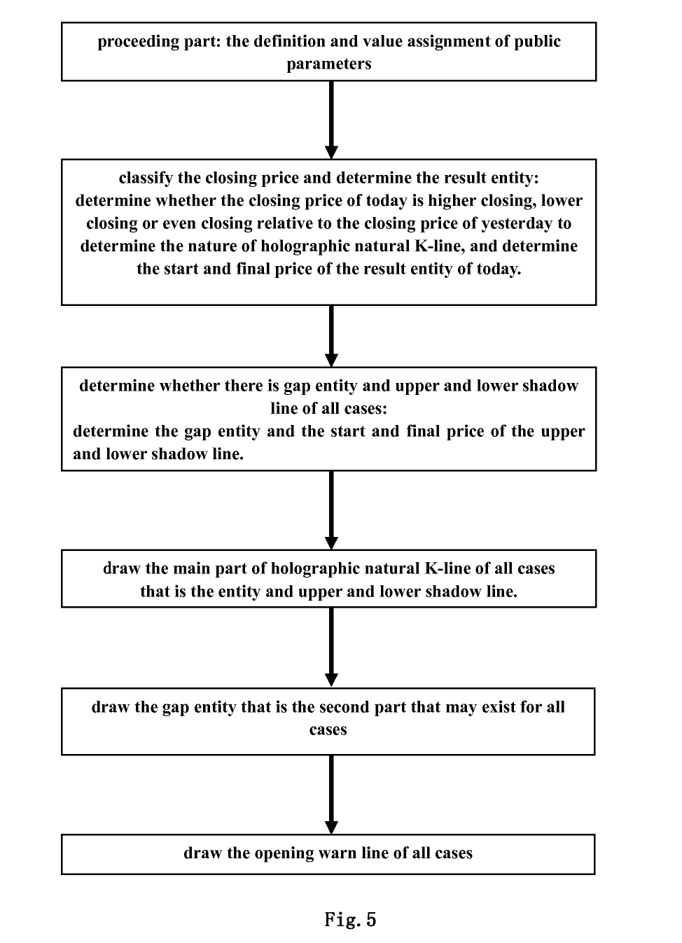

(1) Referring to FIG. 5, the mathematical model of holographic natural K-line is embodied as K-line graph technology index, and constitutes a new holographic natural K-line via program language of stock technology analysis software, which becomes a new stock price line type and core stock price index of the stock and security technology analysis software.

(2) Thereby, the present invention is an independent technology analysis theory and method, which can independently applied and also can used for further analysis by combining with other technology index and method.

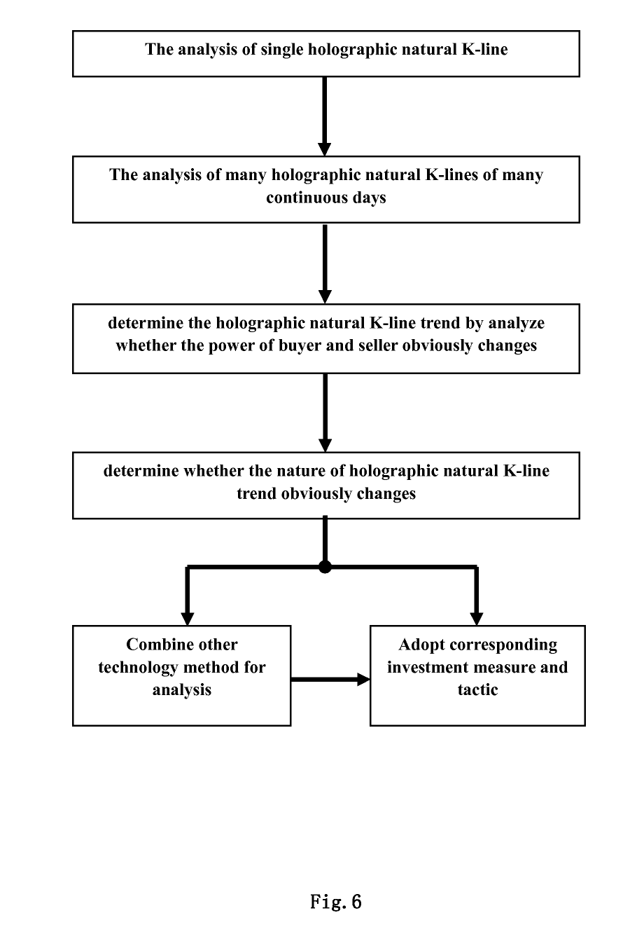

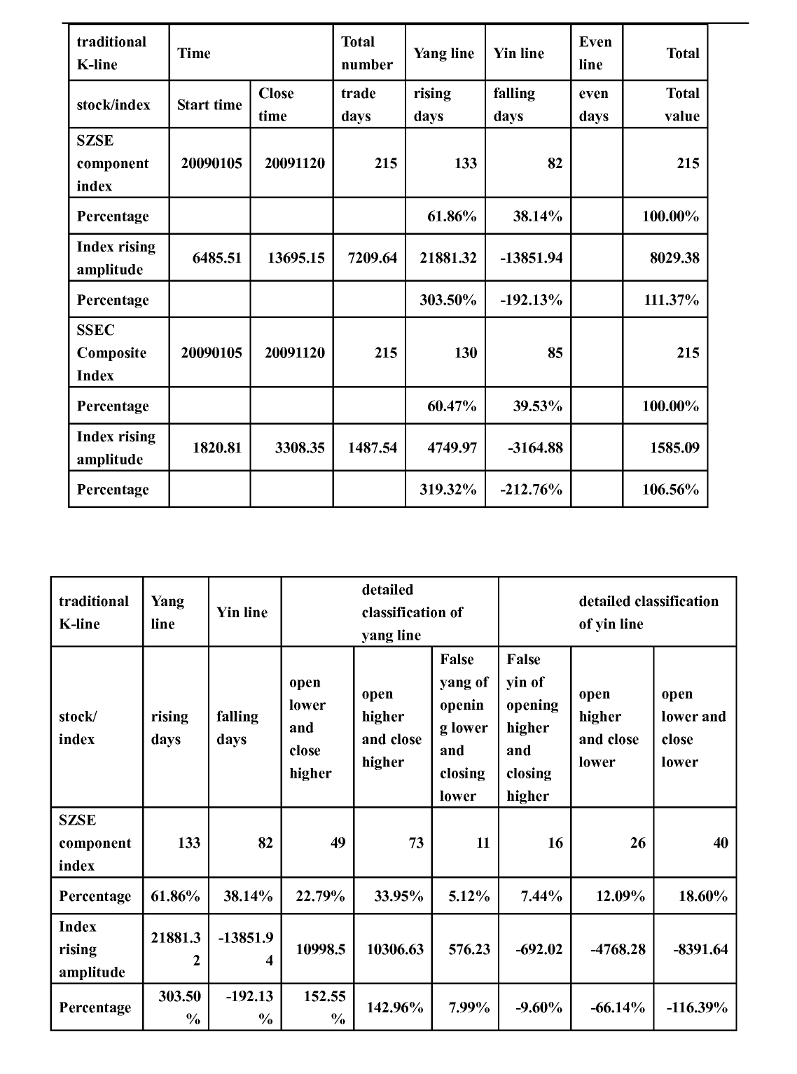

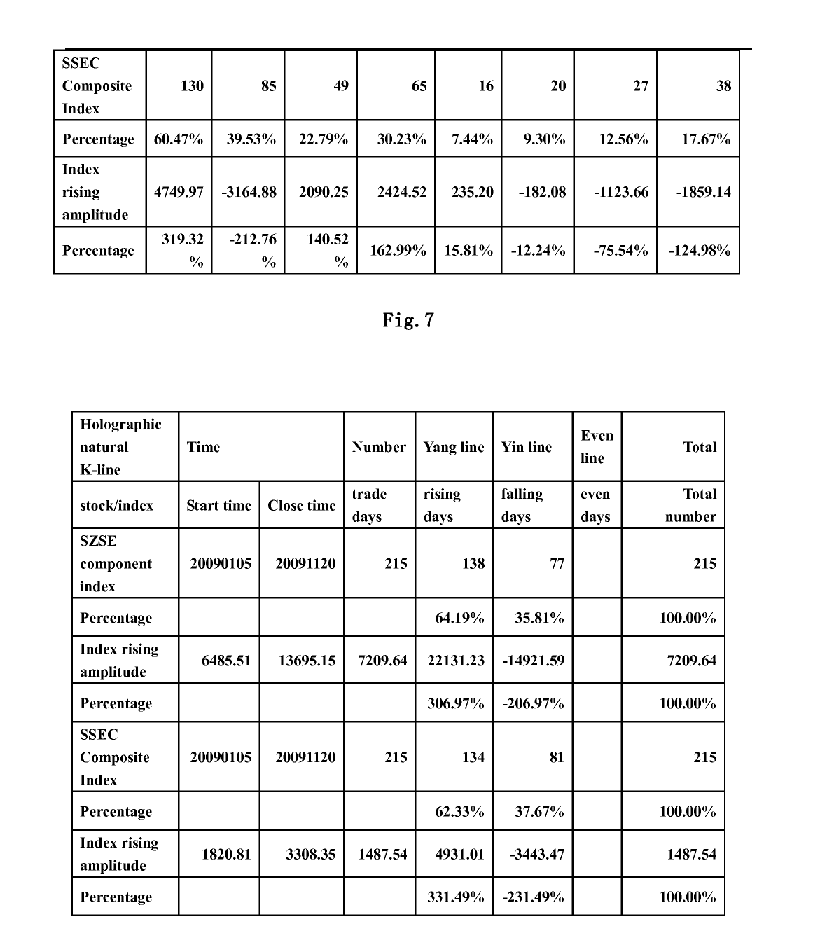

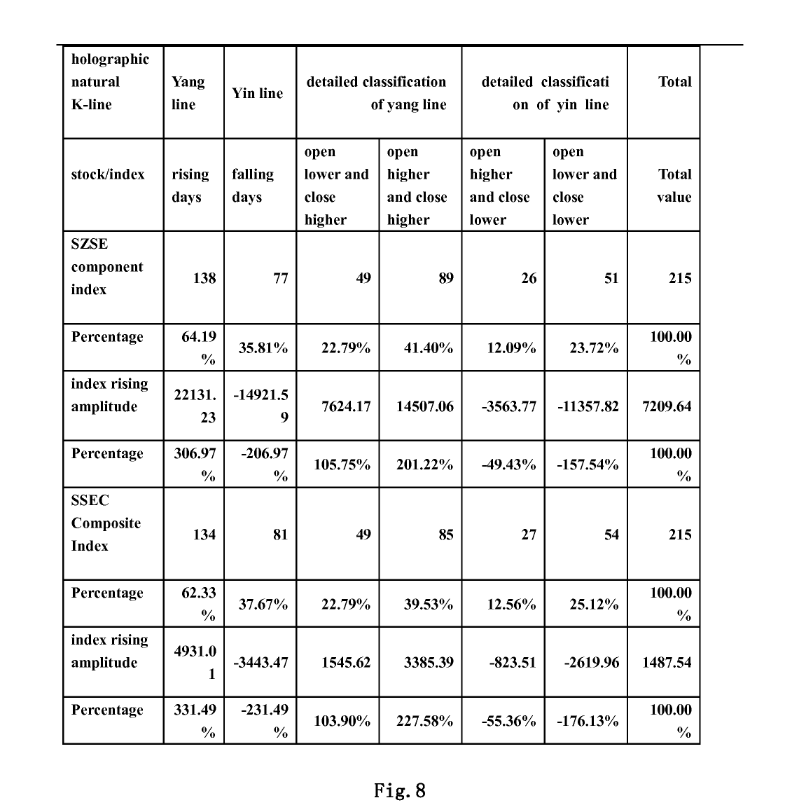

2. FIG. 6 is a schematic diagram of the application to the holographic natural K-line, which includes the flowing parts:

(1) The analysis of single holographic natural K-line;

(2) The analysis of many holographic natural K-lines of many continuous days.

(3) Combine other technology index and method and apply corresponding investment strategy.

3. The application method of single holographic natural K-line:

(1) Firstly, determine the result of the game between buyer and seller of K-line based on the yin line, yang line, even line of single holographic natural K-line.

(2) Secondly, determine the changing amplitude of the power of the buyer and seller based on the size of the result entity of the holographic natural K-line.

(3) Determine based on the gap of holographic natural K-line;

(4) Determine the dominate power based on the position of open warning line relative to the result entity of holographic natural K-line.

(5) Determine the changing process of the power of the buyer and seller based on the position of open warning line relative to the length of the upper and lower shadow line.

4. The application method of holographic natural K-line of continuous days;

(1) Determine whether the power and trend are changing or not via the changes of the result entity from the continuous K-line of holographic natural K-line.

(2) Determine whether the power and trend are changing or not via the changes of position of open warning line relative to the position of result entity from the continuous K-line of holographic natural K-line.

5. Combine other technology index and method to analysis

(1) Analyze and determine the price trend by combining MA average line;

(2) Combine the volume and other technology index for analysis;

(3) Combine other technology method for analysis.

6. The change of using method of the holographic natural K-line graph technology index

In application, the graph of holographic natural K-line graph technology index, entity and open warning line can use different color and width, and solid or broken lines; and middle point can be added into the entity, and MA average line can be also added in the holographic natural K-line for aiding purpose.

The above-mentioned techniques are all based on the mathematical model of holographic natural K-line and holographic natural K-line graph technology index for aid purpose, so that all these changes should under protection of the present invention.

1. A mathematical model of holographic natural K-line, which is a core module and a fundamental and key stock price technology model of an integral stock technology analysis software, collects an information of the opening price, highest price, lowest price, and closing price of each day and the closing price of yesterday, and obtains a series of data calculated from the information and taking the closing price of yesterday as comparison reference, based on which a holographic natural K-line graph technology index is constructed in form a yin and yang K-line that scientifically reflects the process and result of the game of the buyer and seller, and becomes core and foundation of the stock technology analysis,
wherein the main character of the mathematical model of holographic natural K-line (JK) is shown as below:
(1) The structure of the holographic natural K-line (JK):
The holographic natural K-line includes the result entity (JK), gap entity (SPJF), upper shadow line (UJL), lower shadow line (DJL) and open warning line (OJW), five parts in total;
(2) The theory and definition of the mathematical model of holographic natural K-line includes the following five aspects:
A. The open warning line of holographic natural K-line OJW:
The price of opening warn line OJW=the opening price of today O;
B. The result entity of the holographic natural K-line SPJT:
The start price of the result entity OJ=the closing price of yesterday C2; {C2=REF(C,1)}
The closing price of the result entity CJ=the closing price of today C;
The length of result entity SPJTL=the closing price of today C−the closing price of yesterday C2
C. The highest price of the holographic natural K-line HJ:
The highest price HJ=the highest price of today H;
D. The lowest price of the holographic natural K-line LJ:
The lowest price LJ=the lowest price of today L;
E. The definition of the gap entity SPJF and upper and lower shadow line (UJL and DM) of holographic natural K-line:
There are three cases: even closing, higher closing, and lower closing.
Case 1: The stock price of today does not rise or fall (C=C2):
That is to say, when the closing price of today C is equal to the closing price of yesterday C2, that is C=C2, it is defined that there is no rising gap or falling gap relative to the closing price of yesterday C2.
In this case, the holographic natural K-line is a crossing line, and there is no gap entity.
In this case, the upper and lower shadow line is defined as below:
The position of upper shadow line UJL: the highest price of today H˜the closing price of today C;
The length of upper shadow line UJL=the highest price of today H−the closing price of today C;
The position of lower shadow line DJL: the lowest price of today L˜the closing price of yesterday C2;
The length of lower shadow line DJL=the lowest price of today L−the closing price of yesterday C2
Case 2: The stock price of today rises (C>C2):
That is to say, when the closing price of today C is higher than the closing price of yesterday C2, that is C>C2, it will be further classified into two cases:
(a). if the lowest price of today L is lower than or equal to the closing price of yesterday C2, that is C>C2 and L<=C2, it is defined that there is no rising gap of holographic natural K-line:
In this case, the upper and lower shadow line is defined as below:
The position of upper shadow line UM: the highest price of today H˜the closing price of today C;
The length of upper shadow line UJL=the highest price of today H−the closing price of today C;
The position of lower shadow line DJL: the lowest price of today L˜the closing price of yesterday C2;
The length of lower shadow line DJL=the lowest price of today L−the closing price of yesterday C2
The length of gap entity SPJFL=zero; {the length is zero};
In this case, the holographic natural K-line is a rising K-line without gap.
(b). if the lowest price of today L is higher than the closing price of yesterday C2, that is O>C2, C>C2 and L>C2, it is defined that a rising gap of holographic natural K-line exists no matter whether the lowest price of today L is higher than the highest price of yesterday H2.
In this case, the calculation formula of rising gap is defined as below:
The start price of gap OJF=the closing price of yesterday C2;
The final price of gap CJF=the lowest price of today L;
The length of gap entity SPJFL=the lowest price of today L−the closing price of yesterday C2; (positive value)
In this case, the upper and lower shadow line is defined as below:
The position of upper shadow line UM: the highest price of today H˜the closing price of today C;
The length of upper shadow line UM=the highest price of today H−the closing price of today C;
The length of lower shadow line DJL=zero; {the length is zero};
In this case, the holographic natural K-line is a rising yang K-line with a rising gap but without lower shadow line.
Case 3: The stock price of today falls (C<C2):
That is to say, when the closing price of today C is lower than the closing price of yesterday C2, that is C<C2, it will be further classified into two cases:
(a).if the highest price of today H is higher or equal to the closing price of yesterday C2, that is C<C2 and H>=C2, it is defined that there is no falling gap of holographic natural K-line:
In this case, the upper and lower shadow line is defined as below:
The position of upper shadow line UM: the highest price of today H˜the closing price of yesterday C2;
The length of upper shadow line UM=the highest price of today H−the closing price of yesterday C2;
The position of lower shadow line DM: the lowest price of today L˜the closing price of today C;
The length of lower shadow line DM=the lowest price of today L−the closing price of today C;
The length of gap entity SPJFL=zero; {the length is zero};
In this case, the holographic natural K-line is a yin K-line without gap.
(b). if the highest price of today H is lower than the closing price of yesterday C2, that is O<C2, C<C2 and H<C2, it is defined that a falling gap of holographic natural K-line exists no matter whether the highest price of today H is lower than the lowest price of yesterday L2.
In this case, the calculation formula of falling gap is defined as below:
The start price of gap OJF=the closing price of yesterday C2;
The final price of gap CJF=the highest price of today H;
The length of gap entity SPJFL=the highest price of today H−closing price of yesterday C2; (negative value)
In this case, the upper and lower shadow line is defined as below:
The length of upper shadow line UJL=zero; {the length is zero};
The position of lower shadow line DJL: the lowest price of today L˜the closing price of today C;
The length of lower shadow line DJL=the lowest price of today L−the closing price of today C;
In this case, the holographic natural K-line is a falling yin K-line with a falling gap but without upper shadow line.
(3) The calculation formula and method of mathematical model of holographic natural K-line are illustrated as below:
There are three cases: even closing, higher closing and lower closing, when comparing the stock closing price of today with the closing price of yesterday. According to the five principles and definitions of the mathematical model of holographic natural K-line, the calculation formula of all values of the holographic natural K-line is defined as below:
Case 1: The stock price does not rise or fall (C=C2):
That is to say, when the closing price of today C is equal to the closing price of yesterday, that is C=C2, the calculation formula of all values of holographic natural K-line (JK) are shown as below:
The price of opening warn line OJW=the opening price of today O;
The start price of the result entity OJ=the closing price of yesterday C2; {C2=REF(C,1)}
The closing price of the result entity CJ=the closing price of today C;
The length of result entity SPJTL=C−C2=zero; {the length is zero};
The start price of the gap entity OJF=the closing price of yesterday C2; {C2=REF(C,1)}
The final price of the gap entity CJF=the closing price of today C;
The length of gap entity SPJFL=C−C2=zero; {the length is zero};
The position of upper shadow line UJL: the highest price of today H˜the closing price of today C;
The length of upper shadow line UJL: the highest price of today H−the closing price of today C;
The position of lower shadow line DJL: the lowest price of today L˜the closing price of yesterday C2;
The length of lower shadow line DJL: the lowest price of today L−the closing price of yesterday C2;
In this case, the holographic natural K-line is a crossing line, which means that the length of result entity and gap entity are zero.
Case 2: The stock price rises (C>C2):
That is to say, when the closing price of today C is higher than the closing price of yesterday C2, that is C>C2, there will be two cases:
(a). if the lowest price of today L is lower or equal to the closing price of yesterday C2, that is if C>C2 and L<=C2, the calculation formula of all values of holographic natural K-line are shown as below:
The price of opening warn line OJW=the opening price of today O;
The start price of the result entity OJ=the closing price of yesterday C2; {C2=REF(C,1)}
The closing price of the result entity CJ=the closing price of today C;
The length of result entity SPJTL=the closing price of today C−the closing price of yesterday C2;
The start price of gap entity OJF=the closing price of yesterday C2;
The final price of gap entity CJF=the closing price of yesterday C2;
The length of gap entity SPJFL=zero; {the length is zero};
The position of upper shadow line UJL: the highest price of today H˜the closing price of today C;
The length of upper shadow line UJL: the highest price of today H−the closing price of today C;
The position of lower shadow line DJL: the lowest price of today L˜the closing price of yesterday C2;
The length of lower shadow line DJL: the lowest price of today L−the closing price of yesterday C2;
In this case, the holographic natural K-line is a rising yang line without gap entity.
(b). if the lowest price of today L is higher than the closing price of yesterday C2, that is if O>C2, C>C2 and L>C2, the calculation formula of all values of holographic natural K-line are shown as below:
The price of opening warn line OJW=the opening price of today O;
The start price of the result entity OJ=the closing price of yesterday C2; {C2=REF(C,1)}
The closing price of the result entity CJ=the closing price of today C;
The length of result entity SPJTL=the closing price of today C−the closing price of yesterday C2;
The start price of gap entity OJF=the closing price of yesterday C2;
The final price of gap entity CJF=the lowest price of today L;
The length of gap entity SPJFL=the lowest price of today L−the closing price of yesterday C2;
The position of upper shadow line UJL: the highest price of today H˜the closing price of today C;
The length of upper shadow line UJL: the highest price of today H−the closing price of today C;
The position of lower shadow line DJL: the closing price of yesterday C2˜the closing price of yesterday C2;
The length of lower shadow line DJL=zero; {the length is zero};
In this case, the holographic natural K-line is a rising yang line with rising gap entity, but without lower shadow line.
Case 3: The stock price falls (C<C2):
That is to say, when the closing price of today C is lower than the closing price of yesterday C2, that is C<C2, there will be two cases:
(a). if the highest price of today H is higher than or equal to the closing price of yesterday C2, that is if C<C2 and H>=C2, the calculation formula of all values of holographic natural K-line are shown as below:
The price of opening warn line OJW=the opening price of today O;
The start price of the result entity OJ=the closing price of yesterday C2; {C2=REF(C,1)}
The closing price of the result entity CJ=the closing price of today C;
The length of result entity SPJTL=the closing price of today C−the closing price of yesterday C2;
The start price of gap entity OJF=the closing price of yesterday C2;
The length of gap entity SPJFL=zero; {the length is zero};
The position of upper shadow line UJL: the highest price of today H˜the closing price of yesterday C2;
The length of upper shadow line UJL: the highest price of today H−the closing price of yesterday C2;
The position of lower shadow line DJL: the lowest price of today L˜the closing price of today C;
The length of lower shadow line DJL: the lowest price of today L−the closing price of today C;
In this case, the holographic natural K-line is a falling yin line without falling gap entity.
(b). if the highest price of today H is lower than the closing price of yesterday C2, that is if O<C2, C<C2 and H<C2, the calculation formula of all values of holographic natural K-line are shown as below:
The price of opening warn line OJW=the opening price of today O;
The start price of the result entity OJ=the closing price of yesterday C2; {C2=REF(C,1)}
The closing price of the result entity CJ=the closing price of today C;
The length of result entity SPJTL=the closing price of today C−the closing price of yesterday C2;
The start price of gap entity OJF=the closing price of yesterday C2;
The final price of gap entity CJF=the highest price of today H;
The length of gap entity SPJFL=the highest price of today H−the closing price of yesterday C2;
The position of upper shadow line UJL: the closing price of yesterday C2˜the closing price of yesterday C2;
The length of upper shadow line UJL=zero; {the length is zero};
The position of lower shadow line DJL: the lowest price of today L˜the closing price of today C;
The length of lower shadow line DJL: the lowest price of today L−the closing price of today C;
In this case, the holographic natural K-line is a falling yin line with falling gap entity, but without upper shadow line.

2. Based on the data obtained from theory, definition and formula of mathematical model of holographic natural K-line as recited as claim 1, a programming language of stock and security technology analysis software can be used to construct the mathematical model of holographic natural K-line in form of the traditional K-line to become a holographic natural K-line graph technology index, holographic natural K-line, so as to provide core index for stock price of stock technology analysis and provide tool, foundation and reference for stock technology analysis.
The graph construction and character of the holographic natural K-line are shown as below:
(1) Draw an opening warn line OJW of the holographic natural K-line with an opening price of today, the line width of OJW is slightly wider than the width of the entity of K-line (generally 120%);
(2) Draw a result entity of K-line today beginning from the closing price of yesterday C2 and ending with the closing price of today C, which reflects the natural result of game between the buyer and seller today;
(3) Determine whether gap entity of holographic natural K-line exists or not, and if yes, draw the gap entity of K-line.
(4) Determine whether an upper and lower shadow line of holographic natural K-line exists or not, and draw the corresponding upper shadow line and lower shadow line.
The graph and color of the holographic natural K-line are shown as below:
(1) Graph
For the habit of traditional stock technology analysis, the holographic natural K-line can adopt the graph of the traditional K-line.
(2) Color
For the traditional stock technology analysis habit, the holographic natural K-line can adopt the color of the traditional K-line. That is to say, when the stock price rises today, use red color; when the stock price falls, use green; when the stock price does not rise or fall, use white.
In the design and application, the color and size may vary and have many choices, such as the size, color, broken or solid line are all under protection of this claim.

3. A method of constructing a graph of holographic natural K-line comprising:
(1) drawing an opening warn line (OJW) of the holographic natural K-line with an opening price of today, wherein the line width of OJW is slightly wider than the width of the entity of K-line;
(2) drawing a result entity of K-line today beginning from the closing price of yesterday C2 and ending with the closing price of today C, which reflects the natural result of game between the buyer and seller today;
(3) determining whether gap entity of holographic natural K-line exists or not, and if yes, drawing the gap entity of K-line.
(4) determining whether an upper and lower shadow line of holographic natural K-line exists or not, and drawing the corresponding upper shadow line and lower shadow line.

4. The method as recited in claim 3, wherein the holographic natural K-line can adopt the graph of a traditional K-line, and the holographic natural K-line can adopt the color of the traditional K-line

5. The method as recited in claim 4, wherein the holographic natural K-line uses red color, when the stock price rises today; green, when the stock price falls; white, when the stock price does not rise or fall.
